(19) United States
(12) Patent Application Publication
(10) Pub. No.: US 2026/0221683 A1
(43) Pub. Date: Jul. 30, 2026

(54) TERMINAL AND CONNECTOR

(71) Applicant: SUMITOMO WIRING SYSTEMS, LTD., Mie (JP)

(72) Inventor: Satoshi KAKUDA, Mie (JP)

(21) Appl. No.: 19/454,571

(22) Filed: Jan. 21, 2026

(30) Foreign Application Priority Data
Jan. 28, 2025 (JP) 2025-012174

(51) Int. Cl. H01R 13/11; H01R 13/422

(52) U.S. Cl. CPC H01R 13/113; H01R 13/422

(57) ABSTRACT

A terminal includes: a first spring member that includes a first spring piece and a first connecting portion; and a second spring member that includes a second spring piece that is placed in opposition to the first spring piece and a second connecting portion that is placed in opposition to the first connecting portion. a connecting member that is joined to the first and second connecting portions; and a clip that holds the first and second spring pieces and and applies a pressing force to the first and second spring pieces in a direction that causes the first and second spring pieces to be closer to each other. A mating terminal is inserted between the first spring piece and the second spring piece in a rearward direction. A joint portion is provided on an opposite side of the first and second spring pieces across a linking portion of the clip.

### CROSS-REFERENCE TO RELATED APPLICATIONS

This application is based on and claims priority from Japanese Patent Application No. 2025-012174, filed on Jan. 28, 2025, with the Japan Patent Office, the disclosure of which is incorporated herein in its entirety by reference.

### TECHNICAL FIELD

The present disclosure relates to a terminal and a connector.

### BACKGROUND

Conventionally, as a terminal included in a connector, a terminal that includes a hollow tubular conductor portion and a contact point forming metal fitting that is conductively fixed to the tubular conductor portion has been proposed (see, for example, JP 2024-105976A). The contact point forming metal fitting and the tubular conductor portion are separately molded through pressing, and then they are joined to each other through welding or the like. The contact point forming metal fitting includes a spring piece that projects toward the inside of the tubular conductor portion. As a result of the spring piece of the contact point forming metal fitting coming into elastic contact with a mating terminal that is inserted into the tubular conductor portion, the terminal is electrically connected to the mating terminal.

### SUMMARY

With the terminal described above, it is necessary to prepare a protective material for protecting the spring piece when joining the tubular conductor portion and the contact point forming metal fitting to each other through welding or the like, which causes a problem of increasing the complexity of the production process.

It is an object of the present disclosure to provide a terminal and a connector whose production process can be simplified.

A terminal according to the present disclosure is a terminal that is electrically connected to a mating terminal, the terminal including: a first spring member that includes a first spring piece and a first connecting portion; a second spring member that includes a second spring piece and a second connecting portion, the second spring piece being placed in opposition to the first spring piece, and the second connecting portion being placed in opposition to the first connecting portion; a connecting member that is joined to the first connecting portion and the second connecting portion; and a clip that holds the first spring piece and the second spring piece and applies a pressing force to the first spring piece and the second spring piece in a direction that causes the first spring piece and the second spring piece to be closer to each other, wherein the mating terminal is inserted between the first spring piece and the second spring piece in a first direction, the clip includes a pair of arm portions that hold the first spring piece and the second spring piece and a linking portion that links the pair of arm portions, and a joint portion where the first connecting portion and the second connecting portion are joined to the connecting member is provided on an opposite side of the first spring piece and the second spring piece across the linking portion of the clip.

With the terminal and the connector according to the present disclosure, it is possible to obtain the advantageous effect of simplifying the production process.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector according to one embodiment.

FIG. 2 is an exploded perspective view of the connector according to the embodiment.

FIG. 3 is a cross-sectional view of the connector according to the embodiment.

FIG. 4 is an exploded perspective view of a terminal according to one embodiment.

FIG. 5 is a perspective view of a terminal according to a variation.

FIG. 6 is a cross-sectional view of a connector according to a variation.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiment of the Present Disclosure

First, aspects of an embodiment according to the present disclosure will be listed and described.
[1] A terminal according to the present disclosure is a terminal that is electrically connected to a mating terminal, the terminal including: a first spring member that includes a first spring piece and a first connecting portion; a second spring member that includes a second spring piece and a second connecting portion, the second spring piece being placed in opposition to the first spring piece, and the second connecting portion being placed in opposition to the first connecting portion; a connecting member that is joined to the first connecting portion and the second connecting portion; and a clip that holds the first spring piece and the second spring piece and applies a pressing force to the first spring piece and the second spring piece in a direction that causes the first spring piece and the second spring piece to be closer to each other, wherein the mating terminal is inserted between the first spring piece and the second spring piece in a first direction, the clip includes a pair of arm portions that hold the first spring piece and the second spring piece and a linking portion that links the pair of arm portions, and a joint portion where the first connecting portion and the second connecting portion are joined to the connecting member is provided on an opposite side of the first spring piece and the second spring piece across the linking portion of the clip.

With this configuration, the joint portion where the first connecting portion of the first spring member and the second connecting portion of the second spring member are joined to the connecting member is provided on the opposite side of the first spring piece and the second spring piece across the linking portion of the clip. Accordingly, the joint portion is provided at a position that is away from the first spring piece and the second spring piece that functions as contact points for contacting the mating terminal. Also, the linking portion of the clip is provided between (i) the joint portion and (ii) the first spring piece and the second spring piece. With this configuration, when, for example, joining the first connecting portion and the second connecting portion to the connecting member through welding or the like, weld spatter does not stick to the first spring piece and the second spring piece. Accordingly, it is possible to eliminate the need for preparing a protective material for protecting the first spring piece and the second spring piece. As a result, the production process of the terminal can be simplified as compared with that of the conventional terminal that requires preparation of the protective material.
[2] In the terminal according to clause [1], each of the first connecting portion and the second connecting portion may have a flat plate shape, the connecting member may have a flat plate shape, the first connecting portion, the second connecting portion, and the connecting member may be stacked in a second direction that is perpendicular to the first direction, and the joint portion may be a portion where the first connecting portion, the second connecting portion, and the connecting member are welded.

With this configuration, the first connecting portion, the second connecting portion, and the connecting member are stacked in the second direction that is perpendicular to the first direction, or in other words, a direction that does not extend to the first spring piece and the second spring piece, and also the first connecting portion, the second connecting portion, and the connecting member that are stacked are welded. Accordingly, for example, when welding the first connecting portion, the second connecting portion, and the connecting member, it is possible to appropriately prevent energy (heat and the like) applied from the energy source (heat source or the like) to the welded portions from being applied to the first spring piece and the second spring piece. Accordingly, it is possible to appropriately prevent the first spring piece and the second spring piece from being damaged when welding the first connecting portion, the second connecting portion, and the connecting member, without preparing a protective material for protecting the first spring piece and the second spring piece.
[3] In the terminal according to clause [2], the first connecting portion and the second connecting portion may be provided, with the connecting member being interposed therebetween in the second direction.

With this configuration, the first connecting portion, the second connecting portion, and the connecting member can be joined, with the connecting member being interposed between first connecting portion and the second connecting portion.
[4] In the terminal according to clause [2], the first connecting portion, the second connecting portion, and the connecting member may be stacked on top of each other, with the first connecting portion and the second connecting portion that are directly stacked being placed on the connecting member.

With this configuration, the first connecting portion, the second connecting portion, and the connecting member can be joined, with the first connecting portion, the second connecting portion, and the connecting member being stacked in this order in the second direction.
[5] In the terminal according to any one of clauses [2] to [4], the first connecting portion may include a first through hole that extends through the first connecting portion in the second direction, the second connecting portion may include a second through hole that extends through the second connecting portion in the second direction, the connecting member may include a third through hole that extends through the connecting member in the second direction, and the first connecting portion, the second connecting portion, and the connecting member may be joined, with the first through hole, the second through hole, and the third through hole being positioned to overlap each other.

With this configuration, the first connecting portion, the second connecting portion, and the connecting member can be appropriately positioned by positioning the first through hole, the second through hole, and the third through hole to overlap each other. For example, by inserting a positioning pin into the first through hole, the second through hole, and the third through hole that are positioned to overlap each other, the first connecting portion, the second connecting portion, and the connecting member can be appropriately positioned.
[6] In the terminal according to any one of clauses [2] to [5], the connecting member may have a thickness thicker than a thickness of the first spring member and the second spring member.

With this configuration, by configuring the connecting member to be thicker than the first spring member and the second spring member, it is also possible to cope with a large current flow.
[7] In the terminal according to any one of clauses [2] to [6], the first spring member may include a flat plate-shaped first support portion that extends from an end portion of the first spring piece toward the first direction and a flat plate-shaped first linking portion that links the first support portion and the first connecting portion, the second spring member may include a flat plate-shaped second support portion that extends from an end portion of the second spring piece toward the first direction and a flat plate-shaped second linking portion that links the second support portion and the second connecting portion, the first spring piece may be bent at an end portion of the first support portion toward the first direction and extend in the first direction at an inclination to be closer to the second spring piece, and the second spring piece may be bent at an end portion of the second support portion toward the first direction and extend in the first direction at an inclination to be closer to the first spring piece.

With this configuration, the first spring piece is supported by the flat plate-shaped first support portion, and the second spring piece is supported by the flat plate-shaped second support portion. Also, the first connecting portion that is joined to the connecting member is linked to the first support portion by the flat plate-shaped first linking portion, and the second connecting portion that is joined to the connecting member is linked to the second support portion by the flat plate-shaped second linking portion. With this configuration, it is possible to construct the terminal that includes the first spring piece, the second spring piece, and the connecting member, without a conventional tubular conductor portion. As a result, the conventional tubular conductor portion can be omitted, and thus the terminal structure can be simplified.
[8] In the terminal according to clause [7], the first spring member and the second spring member may be components that are separate from each other, and the first spring member and the second spring member may be configured to have the same structure.

With this configuration, the first spring member and the second spring member are configured to have the same structure, and it is therefore possible to prevent an increase in the number of components, more specifically, the type of component, as compared with the case where the first spring member and the second spring member are configured to have different structures.
[9] A connector according to the present disclosure includes: the terminal according to any one of clauses [1] to [8]; and a housing that includes a cavity for housing the terminal.

With this configuration, it is possible to obtain the same advantageous effects as those of the terminal according to clause [1].
[10] In the connector according to clause [9], the housing may include a positioning groove formed in an inner surface of the cavity, and the terminal may include a positioning protrusion that is provided at the connecting member and configured to be capable of being inserted into the positioning groove in a first opposite direction that is a direction opposite to the first direction.

With this configuration, by inserting the positioning protrusion of the connecting member into the positioning groove of the housing in the first opposite direction, the terminal can be appropriately positioned relative to the housing.

### Detailed Description of Embodiment of the Present Disclosure

Specific examples of a terminal and a connector according to the present disclosure will be described below with reference to the drawings. In the drawings, for the sake of ease of description, some constituent elements may be shown in an exaggerated or simplified manner. Also, the dimensional ratio of constituent elements may vary from drawing to drawing. The term “perpendicular” used in the specification of the present application encompasses not only the case where things are strictly perpendicular, but also the case where things are substantially perpendicular within the range where the operation and advantageous effects of an embodiment of the present disclosure can be achieved. The expression “to place in opposition” used in the specification of the present application refers to two surfaces or two members being positioned facing each other. Also, the expression “to place in opposition” used in the specification of the present application encompasses not only the case where two surfaces or two members completely face each other, but also the case where two surfaces or two members partially face each other. Also, the expression “to place in opposition” used in the specification of the present application also encompasses both cases where there is a different member between two members, and where there is nothing between two members. The term “same” used in the specification of the present application encompasses not only the case where things are exactly the same, but also the case where there is a slight difference between things due to the influence of dimensional tolerance or the like. Also, the terms such as “first”, “second”, and “third” in the specification of the present application are used to simply distinguish constituent elements from each other, and thus are not intended to mean the order of constituent elements. In each diagram, a first axial direction X, a second axial direction Y that is perpendicular to the first axial direction X, and a third axial direction Z that is perpendicular to the first axial direction X and the second axial direction Y are shown. Also, a forward direction X1 that is one direction that extends in the first axial direction X and a rearward direction X2 that is another direction that extends in the first axial direction X and is a direction opposite to the forward direction X1 are shown. Furthermore, an upward direction Z1 that is one direction that extends in the third axial direction Z and a downward direction Z2 that is another direction that extends in the third axial direction Z and is a direction opposite to the upward direction Z1 are shown. Note that the directions shown in each diagram do not necessarily show the orientation of the terminal and the connector when in use. The invention of the present application is not limited to the examples given herein. The scope of the invention of the present application is indicated by the appended claims, and all changes that come within the meaning and range of equivalency of the claims are intended to be embraced within the scope of the invention of the present application.

### Configuration of Connector 10

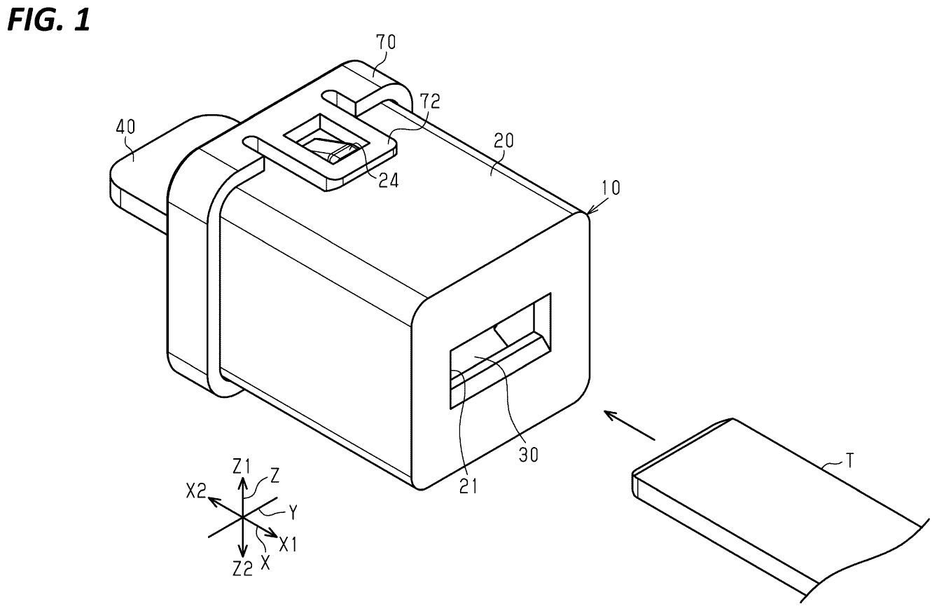

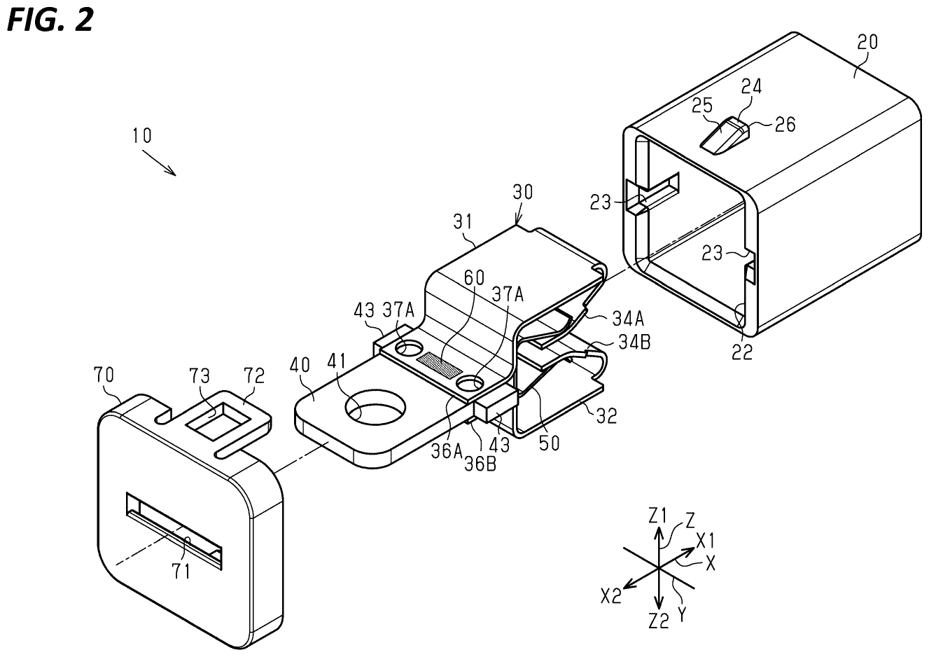

As shown in FIGS. 1 and 2, a connector 10 includes a housing 20, a terminal 30 that is held by the housing 20, and a retainer 70 that is attached to the housing 20. The connector 10 is, for example, a high-voltage connector that can cope with a high voltage and a large current. The connector 10 is fitted to a mating connector (not shown). As shown in FIG. 1, the terminal 30 of the connector 10 is electrically connected to a mating terminal T of the mating connector. In an end surface of the housing 20 in the forward direction X1, an opening portion 21 through which the mating terminal T is inserted in the rearward direction X2 is formed. The mating terminal T is inserted into the terminal 30 within the housing 20.

### Configuration of Housing 20

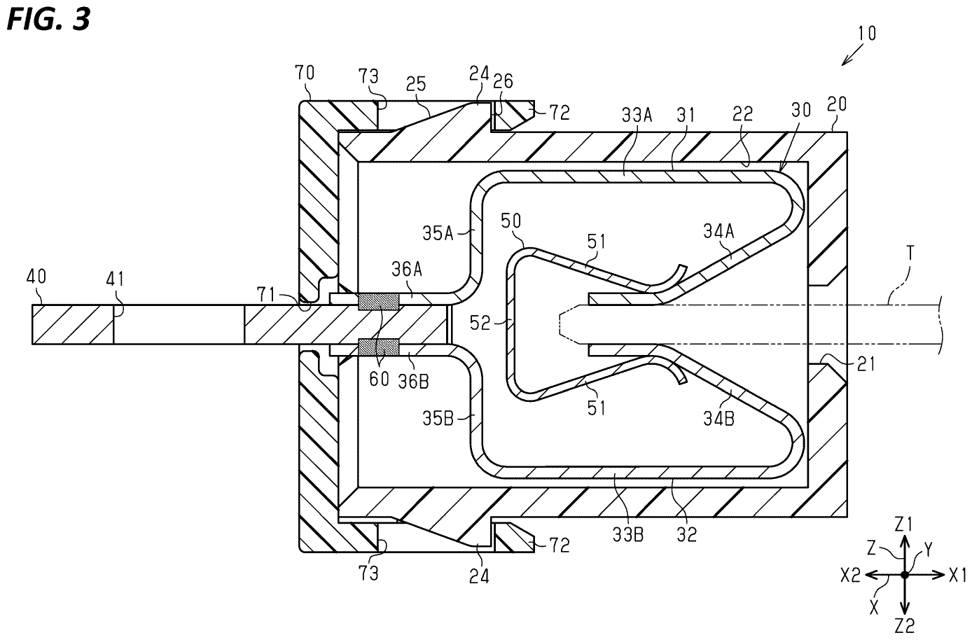

As shown in FIGS. 2 and 3, the housing 20 includes a cavity 22 for housing the terminal 30. As shown in FIG. 3, the mating terminal T is inserted into the cavity 22 via the opening portion 21. The terminal 30 is inserted into the cavity 22 in the forward direction X1 via an opening of the cavity 22 in the rearward direction X2. As shown in FIG. 2, the cavity 22 includes a pair of positioning grooves 23 that are formed in an inner surface of the cavity 22. Each positioning groove 23 is formed to be recessed outward from the inner surface of the cavity 22. Each positioning groove 23 extends in the forward direction X1 from an end surface of the housing 20 in the rearward direction X2. Each positioning groove 23 has an opening in the rearward direction X2 that extends inward into the cavity 22. The pair of positioning grooves 23 are arranged in opposition to each other along the second axial direction Y.

As shown in FIG. 3, the housing 20 includes a pair of engaging portions 24 that are formed on an outer surface of the housing 20. Each engaging portion 24 is formed to protrude outward from the outer surface of the housing 20. Each engaging portion 24 includes an inclined surface 25 and an engaging surface 26. The inclined surface 25 is formed to be inclined outward toward the engaging surface 26. The engaging surface 26 is formed to extend perpendicular to the outer surface of the housing 20. The engaging surface 26 extends in the third axial direction Z.

### Configuration of Terminal 30

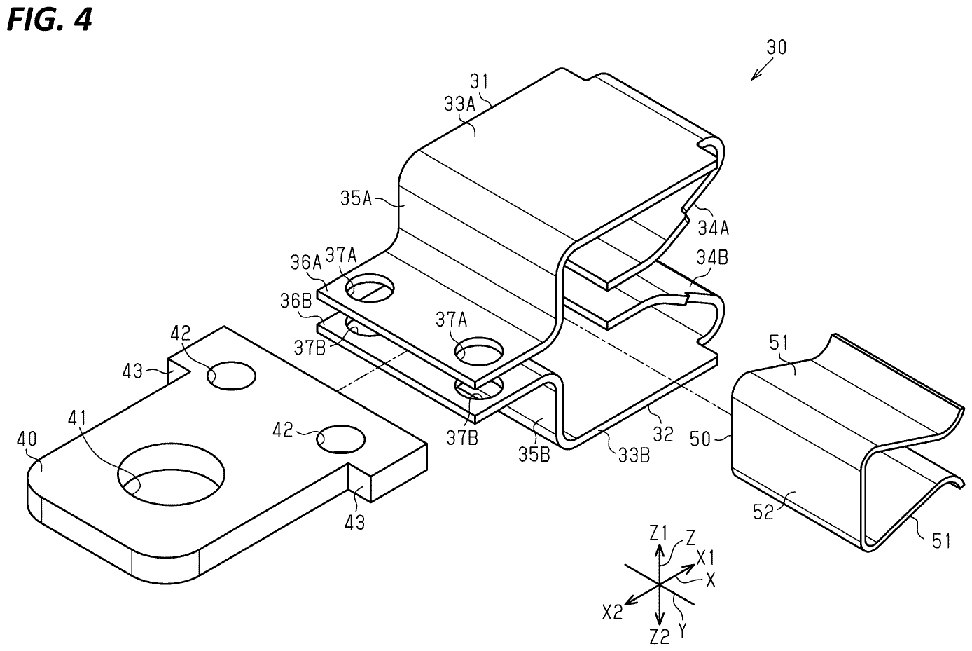

As shown in FIG. 4, the terminal 30 includes a first spring member 31, a second spring member 32, a connecting member 40, and a clip 50. The first spring member 31, the second spring member 32, the connecting member 40, and the clip 50 are components that are separate from each other.

### Configuration of First Spring Member 31 and Second Spring Member 32

Each of the first spring member 31 and the second spring member 32 is formed by pressing, for example, a metal plate. The first spring member 31 and the second spring member 32 constitute electrical contact points for contacting the mating terminal T (see FIG. 3). For this reason, the first spring member 31 and the second spring member 32 are made of a conductor. For example, copper or a copper-based metal is used as the material for the first spring member 31 and the second spring member 32.

As shown in FIG. 3, the first spring member 31 includes a first support portion 33A, a first spring piece 34A, a first linking portion 35A, and a first connecting portion 36A. The second spring member 32 includes a second support portion 33B, a second spring piece 34B, a second linking portion 35B, and a second connecting portion 36B. The first spring member 31 and the second spring member 32 are configured to have, for example, the same structure.

The first support portion 33A and the second support portion 33B are placed in opposition to each other in the third axial direction Z. Each of the first support portion 33A and the second support portion 33B has a flat plate shape. The first support portion 33A extends from an end portion of the first spring piece 34A in the upward direction Z1 toward the rearward direction X2. The second support portion 33B extends from an end portion of the second spring piece 34B in the downward direction Z2 toward the rearward direction X2.

Each of the first spring piece 34A and the second spring piece 34B has a flat plate shape. The first spring piece 34A is bent at an end portion of the first support portion 33A in the forward direction X1 toward the rearward direction X2. The first spring piece 34A is bent in a direction to be closer to the second spring piece 34B, or in other words, toward the downward direction Z2. That is, the first spring piece 34A is bent in a U shape from the end portion of the first support portion 33A in the forward direction X1 toward the rearward direction X2 and the downward direction Z2. The second spring piece 34B is bent at an end portion of the second support portion 33B in the forward direction X1 toward the rearward direction X2. The second spring piece 34B is bent in a direction to be closer to the first spring piece 34A, or in other words, toward the upward direction Z1. That is, the second spring piece 34B is bent in a U shape from the end portion of the second support portion 33B in the forward direction X1 toward the rearward direction X2 and the upward direction Z1. The first spring piece 34A and the second spring piece 34B extend in the rearward direction X2 at an inclination to be closer to each other toward the rearward direction X2. The first spring piece 34A and the second spring piece 34B are located between the first support portion 33A and the second support portion 33B. The first spring piece 34A and the second spring piece 34B are placed in opposition to each other in the third axial direction Z. The mating terminal T is inserted between the first spring piece 34A and the second spring piece 34B in the rearward direction X2. As a result of the first spring piece 34A and the second spring piece 34B coming into elastic contact with the mating terminal T, the terminal 30 and the mating terminal T are electrically connected.

Each of the first linking portion 35A and the second linking portion 35B has a flat plate shape. The first linking portion 35A is configured to link the first support portion 33A and the first connecting portion 36A. The first linking portion 35A extends from an end portion of the first support portion 33A in the rearward direction X2 toward the downward direction Z2. The second linking portion 35B is configured to link the second support portion 33B and the second connecting portion 36B. The second linking portion 35B extends from the end portion of the second support portion 33B in the rearward direction X2 toward the upward direction Z1.

Each of the first connecting portion 36A and the second connecting portion 36B has a flat plate shape. The first connecting portion 36A extends from an end portion of the first linking portion 35A in the downward direction Z2 toward the rearward direction X2. The second connecting portion 36B extends from an end portion of the second linking portion 35B in the upward direction Z1 toward the rearward direction X2. The first connecting portion 36A and the second connecting portion 36B extend in a direction to be away from the first spring piece 34A and the second spring piece 34B. The first connecting portion 36A and the second connecting portion 36B are placed in opposition to each other in the third axial direction Z. The first connecting portion 36A and the second connecting portion 36B are provided with the connecting member 40 being interposed between the first connecting portion 36A and the second connecting portion 36B.

As shown in FIG. 4, the first connecting portion 36A includes, for example, one or more (two in the present embodiment) first through holes 37A. The two first through holes 37A are arranged side by side along the second axial direction Y. Each first through hole 37A is formed to extend through the first connecting portion 36A in the third axial direction Z. The second connecting portion 36B includes, for example, one or more (two in the present embodiment) second through holes 37B. The two second through holes 37B are arranged side by side along the second axial direction Y. The two second through holes 37B are arranged to respectively overlap the two first through holes 37A when viewed in a plan view from the downward direction Z2. Each second through hole 37B is formed to extend through the second connecting portion 36B in the third axial direction Z.

Here, the first spring member 31 is formed using a single metal plate material. The first spring member 31 has a uniform thickness throughout, for example, the entire first spring member 31. That is, the first support portion 33A, the first spring piece 34A, the first linking portion 35A, and the first connecting portion 36A are configured to have the same thickness. The second spring member 32 is formed using a single metal plate material. The second spring member 32 has a uniform thickness throughout, for example, the entire second spring member 32. That is, the second support portion 33B, the second spring piece 34B, the second linking portion 35B, and the second connecting portion 36B are configured to have the same thickness.

### Configuration of Clip 50

As shown in FIG. 3, the clip 50 is attached to leading end portions of the first spring piece 34A and the second spring piece 34B (in this example, end portions of the first spring piece 34A and the second spring piece 34B in the rearward direction X2). The clip 50 applies a pressing force to the first spring piece 34A and the second spring piece 34B in a direction that causes the first spring piece 34A and the second spring piece 34B to be closer to each other. The clip 50 is formed by pressing, for example, a metal plate. Note that the clip 50 does not constitute an electrical circuit in the terminal 30. For this reason, as the material for the clip 50, it is possible to use a material unlikely to conduct electricity or an insulator. As the material for the clip 50, for example, stainless steel can be used.

The clip 50 includes a pair of arm portions 51 that hold the first spring piece 34A and the second spring piece 34B, and a linking portion 52 that links the pair of arm portions 51. The pair of arm portions 51 are inclined from the linking portion 52 in a direction that causes the pair of arm portions 51 to be closer to each other toward the forward direction X1. The pair of arm portions 51 exert spring forces in directions that cause the pair of arm portions 51 to be closer to each other. The first spring piece 34A and the second spring piece 34B that are placed in opposition to each other in the third axial direction Z are urged in a direction that causes the first spring piece 34A and the second spring piece 34B to be closer to each other by the elasticity of the clip 50. With this configuration, even if the terminal 30 and the mating terminal T are misaligned in the third axial direction Z due to production tolerance or the like, a clamping force (contact pressure) by the first spring piece 34A and the second spring piece 34B that holds the mating terminal T changes as little as possible.

The linking portion 52 links end portions of the pair of arm portions 51 in the rearward direction X2. The linking portion 52 has a flat plate shape that extends in a plane perpendicular to the first axial direction X. The linking portion 52 is provided

between (i) the first spring piece 34A and the second spring piece 34B and (ii) the first connecting portion 36A and the second connecting portion 36B in the first axial direction X

### Configuration of Connecting Member 40

As shown in FIG. 4, the connecting member 40 has a flat plate shape. The connecting member 40 has a rectangular planar shape as a whole when viewed from the downward direction Z2. As shown in FIG. 3, an end portion of the connecting member 40 in the forward direction X1 is held by the first connecting portion 36A and the second connecting portion 36B from both sides in the third axial direction Z. That is, the first connecting portion 36A, the connecting member 40, and the second connecting portion 36B are stacked in this order in the downward direction Z2. The connecting member 40 extends from the first connecting portion 36A and the second connecting portion 36B toward the rearward direction X2. For example, a conductor member (not shown) is fixed to the connecting member 40 by fastening a bolt. The connecting member 40 is electrically connected to the conductor member (not shown). The conductor member may be, for example, a terminal end of an electric wire, a bus bar, or the like. The connecting member 40 includes an insertion hole 41 through which a bolt (not shown) is inserted. The insertion hole 41 is formed to extend through the connecting member 40 in the third axial direction Z.

The connecting member 40 is formed using a single metal plate material. The connecting member 40 has a uniform thickness throughout, for example, the entire connecting member 40. The connecting member 40 has a thickness thicker than a thickness of the first spring member 31 and the second spring member 32. The connecting member 40 is formed to have, for example, a thickness that is two or more times thicker than the thickness of the first spring member 31 and the second spring member 32.

As shown in FIG. 4, the connecting member 40 includes, for example, one or more (two in the present embodiment) third through holes 42. The two third through holes 42 are arranged side by side along the second axial direction Y. The third through holes 42 are arranged to respectively overlap the first through hole 37A and the second through hole 37B when viewed in a plan view from the downward direction Z2. Each third through hole 42 is formed to extend through the connecting member 40 in the third axial direction Z.

As shown in FIG. 3, the connecting member 40 is joined to the first connecting portion 36A and the second connecting portion 36B. The connecting member 40 is integrated with the first connecting portion 36A and the second connecting portion 36B, and electrically connected to the first connecting portion 36A and the second connecting portion 36B. In a joint portion 60 where the connecting member 40 is joined to the first connecting portion 36A and the second connecting portion 36B, for example, the first connecting portion 36A, the connecting member 40, and the second connecting portion 36B that are stacked in the downward direction Z2 are joined through welding. Specifically, the joint portion 60 of the present embodiment includes a portion where the first connecting portion 36A and the connecting member 40 are joined through welding and a portion where the second connecting portion 36B and the connecting member 40 are joined through welding. That is, in the joint portion 60 of the present embodiment, the connecting member 40 is separately welded to the first connecting portion 36A and the second connecting portion 36B. As the welding method, for example, a known welding method can be used such as laser welding, arc welding, gas welding, or spot welding. The method for joining the connecting member 40 to the first connecting portion 36A and the second connecting portion 36B is not limited to welding, and the connecting member 40 can be joined to the first connecting portion 36A and the second connecting portion 36B using, for example, an adhesive, dowel caulking, screw fastening, or the like.

The joint portion 60 is provided at a position that is away from the leading end portions of the first spring piece 34A and the second spring piece 34B that function as contact points for contacting the mating terminal T in the rearward direction X2. The joint portion 60 is provided at a position that is away from the linking portion 52 of the clip 50 in the rearward direction X2. In other words, the joint portion 60 is provided on an opposite side of the first spring piece 34A and the second spring piece 34B across the linking portion 52 of the clip 50.

As shown in FIG. 2, the joint portion 60 is provided between the two first through holes 37A in the second axial direction Y. The joint portion 60 extends in the second axial direction Y, for example, between the two first through holes 37A.

The first spring member 31, the second spring member 32, and the connecting member 40 are joined, with, for example, the first through holes 37A, the second through holes 37B, and the third through holes 42 shown in FIG. 4 being positioned to overlap each other. At this time, rod-shaped positioning pins (not shown) are inserted into the first through holes 37A, the second through holes 37B, and the third through holes 42 that are positioned to overlap each other. The first spring member 31, the second spring member 32, and the connecting member 40 are thereby positioned. Then, welding or the like is performed on the first spring member 31, the second spring member 32, and the connecting member 40 that are positioned as described above, whereby the joint portion 60 is formed.

The connecting member 40 includes, for example, one or more (two in the present embodiment) positioning protrusions 43. Each positioning protrusion 43 is formed to protrude outward from a side surface of the connecting member 40, specifically, from an end surface of the connecting member 40 in the second axial direction Y. Each positioning protrusion 43 extends in the second axial direction Y. Each positioning protrusion 43 protrudes outward relative to, for example, a side surface of the first spring member 31 and a side surface of the second spring member 32. Each positioning protrusion 43 is configured to be capable of being inserted into the corresponding one of the positioning grooves 23 of the housing 20. As a result of each positioning protrusion 43 being inserted into the corresponding positioning groove 23, the terminal 30 can be positioned relative to the cavity 22. To explain in detail, as a result of each positioning protrusion 43 being inserted to a far end of the corresponding positioning groove 23 (in this example, an end portion of the corresponding positioning groove 23 in the forward direction X1), the movement of the terminal 30 in the forward direction X1 is restricted, and the movement of the terminal 30 in the upward direction Z1 and the downward direction Z2 is also restricted.

### Configuration of Retainer 70

As shown in FIG. 3, the retainer 70 is attached to an end portion of the housing 20 in the rearward direction X2. The retainer 70 is provided to close the opening of the cavity 22 in the rearward direction X2. The retainer 70 has a function of preventing the terminal 30 from escaping from the cavity 22. The retainer 70 is made of, for example, a synthetic resin.

The retainer 70 includes a through hole 71. The through hole 71 is formed to extend through the retainer 70 in the first axial direction X. The through hole 71 is sized to allow insertion of the connecting member 40. The through hole 71 is sized to not allow insertion of the first connecting portion 36A, the connecting member 40, and the second connecting portion 36B that are stacked on top of each other. Accordingly, the movement of the terminal 30 in the rearward direction X2 can be restricted by the retainer 70. The connecting member 40 of the terminal 30 extends outside the cavity 22 via the through hole 71.

The retainer 70 includes one or more (two in the present embodiment) engaging portions 72. The two engaging portions 72 are configured to be capable of engaging with the two engaging portions 24, respectively. Each engaging portion 72 is an elastic piece that is formed to protrude toward the corresponding engaging portion 24 and be elastically deformable in a radial direction of the housing 20. Each engaging portion 72 is formed as, for example, a rectangular frame body, and includes an engaging hole 73 at a center of the rectangular frame body, the engaging hole 73 being configured to be capable of engaging with the engaging surface 26 of the engaging portion 24. As a result of the engaging portion 72 and the engaging portion 24 being engaged, a state in which the retainer 70 is attached to the housing 20 is maintained.

### Advantageous Effects of the Present Embodiment

Hereinafter, the advantageous effects of the present embodiment will be described.
(1) The terminal 30 that is electrically connected to the mating terminal T includes: the first spring member 31 that includes the first spring piece 34A and the first connecting portion 36A; and the second spring member 32 that includes the second spring piece 34B that is placed in opposition to the first spring piece 34A and the second connecting portion 36B that is placed in opposition to the first connecting portion 36A. The terminal 30 includes: the connecting member 40 that is joined to the first connecting portion 36A and the second connecting portion 36B; and the clip 50 that holds the first spring piece 34A and the second spring piece 34B and applies the pressing force to the first spring piece 34A and the second spring piece 34B in a direction that causes the first spring piece 34A and the second spring piece 34B to be closer to each other. The mating terminal T is inserted between the first spring piece 34A and the second spring piece 34B in the first direction (in this example, the rearward direction X2). The clip 50 includes the pair of arm portions 51 that hold the first spring piece 34A and the second spring piece 34B and the linking portion 52 that links the pair of arm portions 51. The joint portion 60 where the first connecting portion 36A and the second connecting portion 36B are joined to the connecting member 40 is provided on the opposite side of the first spring piece 34A and the second spring piece 34B across the linking portion 52 of the clip 50.

With this configuration, the joint portion 60 where the first connecting portion 36A and the second connecting portion 36B are joined to the connecting member 40 is provided on the opposite side of the first spring piece 34A and the second spring piece 34B across the linking portion 52 of the clip 50. Accordingly, the joint portion 60 is provided at a position that is away from the first spring piece 34A and the second spring piece 34B that function as contact points for contacting the mating terminal T. Also, the linking portion 52 of the clip 50 is provided between (i) the joint portion 60 and (ii) the first spring piece 34A and the second spring piece 34B. With this configuration, when, for example, joining the first connecting portion 36A and the second connecting portion 36B to the connecting member 40 through welding or the like, weld spatter does not stick to the first spring piece 34A and the second spring piece 34B. Accordingly, it is possible to eliminate the need for preparing a protective material for protecting the first spring piece 34A and the second spring piece 34B. As a result, the production process of the terminal 30 can be simplified as compared with that of the conventional terminal that requires preparation of the protective material. Furthermore, the production cost of the terminal 30 can be reduced by an amount corresponding to the omission of the preparation of the protective material.
(2) The first connecting portion 36A, the second connecting portion 36B, and the connecting member 40 are stacked in the second direction (in this example, the direction that extends in the third axial direction Z) that is perpendicular to the rearward direction X2. The joint portion 60 is the portion where the first connecting portion 36A, the second connecting portion 36B, and the connecting member 40 are welded. With this configuration, the first connecting portion 36A, the second connecting portion 36B, and the connecting member 40 are stacked in a direction that does not extend to the first spring piece 34A and the second spring piece 34B, and also the first connecting portion 36A, the second connecting portion 36B, and the connecting member 40 that are stacked are welded. Accordingly, for example, when welding the first connecting portion 36A, the second connecting portion 36B, and the connecting member 40, it is possible to appropriately prevent energy (heat and the like) applied from the energy source (heat source or the like) to the welded portions from being applied to the first spring piece 34A and the second spring piece 34B. Accordingly, it is possible to appropriately prevent the first spring piece 34A and the second spring piece 34B from being damaged when welding the first connecting portion 36A, the second connecting portion 36B, and the connecting member 40, without preparing the protective material for protecting the first spring piece 34A and the second spring piece 34B.
(3) The first connecting portion 36A, the second connecting portion 36B, and the connecting member 40 are joined, with the first through hole 37A, the second through hole 37B, and the third through hole 42 being positioned to overlap each other. With this configuration, for example, by inserting a positioning pin into the first through hole 37A, the second through hole 37B, and the third through hole 42 that are positioned to overlap each other, the first connecting portion 36A, the second connecting portion 36B, and the connecting member 40 can be appropriately positioned.
(4) The connecting member 40, the first spring member 31, and the second spring member 32 are configured as components that are separate from each other. With this configuration, the material, thickness, and the like can be individually set for each of the connecting member 40, the first spring member 31, and the second spring member 32. Also, for example, when making a change to the vehicle specifications, it is possible to cope with the change in the vehicle specifications by changing only the structure of one (for example, the connecting member 40) of the connecting member 40, the first spring member 31, and the second spring member 32.
(5) In the terminal 30, the first spring piece 34A is supported by the flat plate-shaped first support portion 33A, and the second spring piece 34B is supported by the flat plate-shaped second support portion 33B. Also, in the terminal 30, the first connecting portion 36A that is joined to the connecting member 40 is linked to the first support portion 33A by the flat plate-shaped first linking portion 35A, and the second connecting portion 36B that is joined to the connecting member 40 is linked to the second support portion 33B by the flat plate-shaped second linking portion 35B. With this configuration, it is possible to construct the terminal 30 that includes the first spring piece 34A and the second spring piece 34B that are connected to the mating terminal T, and the connecting member 40 that is connected to the conductive member (not shown), without the conventional tubular conductor portion. As a result, the conventional tubular conductor portion can be omitted, and thus the structure of the terminal 30 can be simplified.
(6) Here, a conventional terminal has an integrated structural body of a tubular conductor portion that houses a contact point forming metal fitting and a flat plate-shaped connecting portion that is electrically connected to a conductor member. The structural body is formed by punching a single metal plate into a predetermined shape. At this time, the structural body has a complex unfolded shape, which increases disposal loss of the punched metal plate. In contrast, in the terminal of the present embodiment, the structure was changed to a structure that includes only the flat plate-shaped connecting member 40 by omitting the conventional tubular conductor portion. With this configuration, the shape of the connecting member 40 can be simplified as compared with that of the above-described structural body, and thus the disposal loss of the punched metal plate can be minimized.
(7) The first spring member 31 and the second spring member 32 are configured to have the same structure, and it is therefore possible to prevent an increase in the number of components, more specifically, the type of component, as compared with the case where the first spring member 31 and the second spring member 32 are configured to have different structures.
(8) The terminal 30 is housed in the cavity 22 of the housing 20. With this configuration, the housing 20 can appropriately protect the terminal 30 that does not include a box-shaped conductor portion.
(9) By inserting the positioning protrusion 43 of the connecting member 40 into the positioning groove 23 of the housing 20 in the first opposite direction (in this example, the forward direction X1), the terminal 30 can be appropriately positioned relative to the housing 20.

### Other Embodiments

The embodiment given above can be modified and carried out as follows. The embodiment given above and variations described below can be combined and carried out as appropriate unless they are technically contradictory to each other.
In the embodiment given above, the first connecting portion 36A and the second connecting portion 36B are provided, with the connecting member 40 being interposed between the first connecting portion 36A and the second connecting portion 36B. However, the present disclosure is not limited thereto.

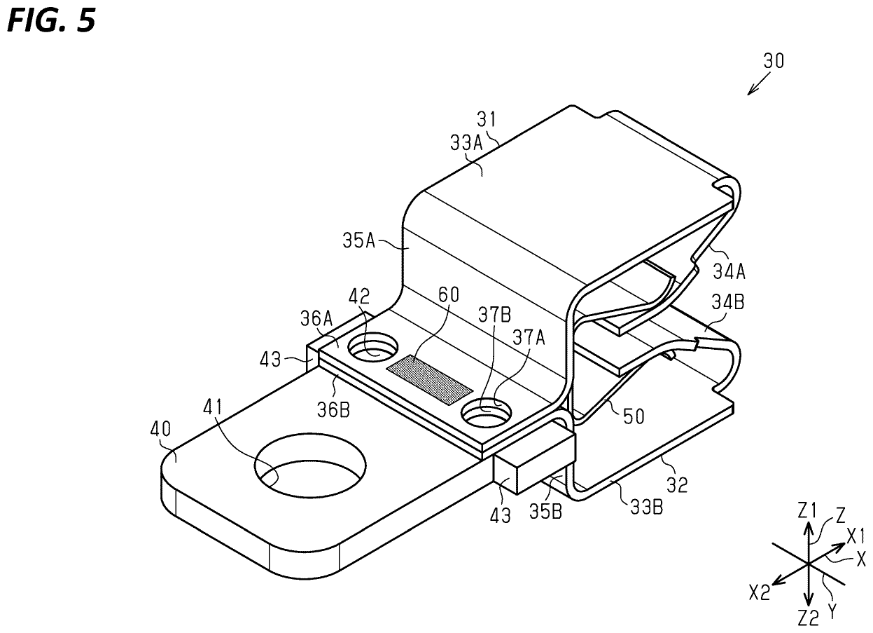

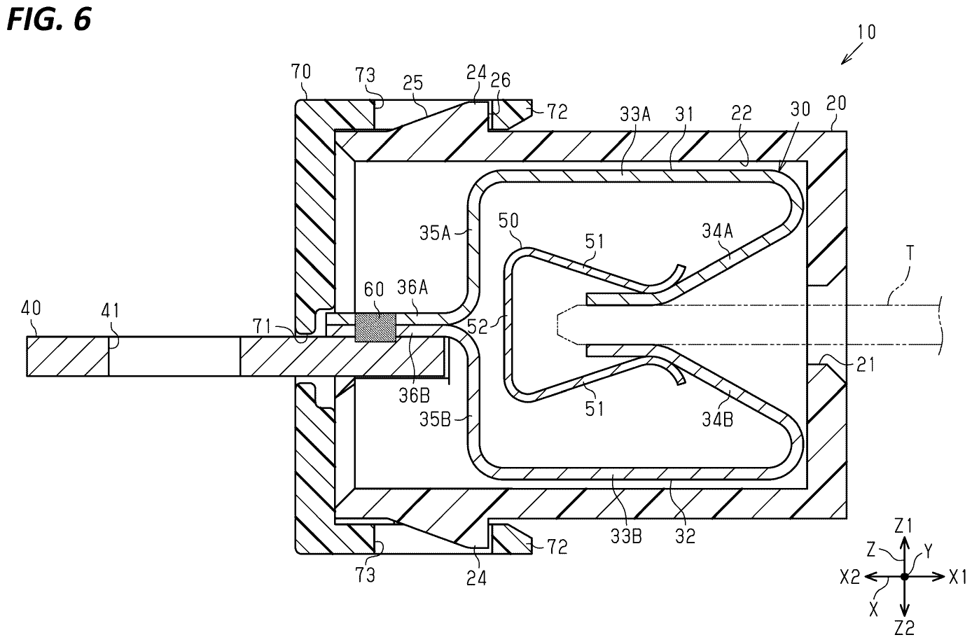

For example, as shown in FIGS. 5 and 6, the first connecting portion 36A and the second connecting portion 36B may be directly stacked, and then the first connecting portion 36A and the second connecting portion 36B that are directly stacked may be stacked on the connecting member 40. In this case, the first connecting portion 36A, the second connecting portion 36B, and the connecting member 40 are stacked in this order in the downward direction Z2. Then, the first connecting portion 36A, the second connecting portion 36B, and the connecting member 40 that are stacked in this way are joined by the joint portion 60. In the joint portion 60 according to this variation, the first connecting portion 36A, the second connecting portion 36B, and the connecting member 40 that are stacked are joined through welding. Even in this case as well, as shown in FIG. 5, the first connecting portion 36A, the second connecting portion 36B, and the connecting member 40 are joined, with the first through hole 37A, the second through hole 37B, and the third through hole 42 being positioned to overlap each other.
In the embodiment given above, the first connecting portion 36A, the second connecting portion 36B, and the connecting member 40 are stacked in the third axial direction Z. However, the present disclosure is not limited thereto. For example, the first connecting portion 36A, the second connecting portion 36B, and the connecting member 40 may be stacked in the second axial direction Y.
In the embodiment given above, the first through hole 37A, the second through hole 37B, and the third through hole 42 are formed to position the first connecting portion 36A, the second connecting portion 36B, and the connecting member 40. However, the positioning structure is not limited thereto as long as it is possible to position the first connecting portion 36A, the second connecting portion 36B, and the connecting member 40.
The first through hole 37A, the second through hole 37B, and the third through hole 42 of the embodiment given above may be omitted.
In the embodiment given above, the connecting member 40 is configured to have a thickness thicker than the thickness of the first spring member 31 and the second spring member 32. However, the present disclosure is not limited thereto. For example, the connecting member 40 may be configured to have a thickness equal to the thickness of the first spring member 31 and the second spring member 32.
In the embodiment given above, the first spring member 31 and the second spring member 32 are configured as components that are separate from each other. However, the present disclosure is not limited thereto. For example, a single component in which the first spring member 31 and the second spring member 32 are integrally formed may be used.
In the embodiment given above, the first spring member 31 and the second spring member 32 may be configured to have different structures.
In the embodiment given above, the positioning groove 23 and the positioning protrusion 43 are provided to position the terminal 30 relative to the housing 20. However, the positioning structure is not limited thereto as long as it is possible to position the terminal 30 relative to the housing 20.
The positioning protrusion 43 and the positioning groove 23 of the embodiment given above may be omitted.
The retainer 70 of the embodiment given above may be omitted.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminal that is electrically connected to a mating terminal, the terminal comprising:
a first spring member that includes a first spring piece and a first connecting portion;
a second spring member that includes a second spring piece and a second connecting portion, the second spring piece being placed in opposition to the first spring piece, and the second connecting portion being placed in opposition to the first connecting portion;
a connecting member that is joined to the first connecting portion and the second connecting portion; and
a clip that holds the first spring piece and the second spring piece and applies a pressing force to the first spring piece and the second spring piece in a direction that causes the first spring piece and the second spring piece to be closer to each other,
wherein the mating terminal is inserted between the first spring piece and the second spring piece in a first direction,
the clip includes a pair of arm portions that hold the first spring piece and the second spring piece and a linking portion that links the pair of arm portions, and
a joint portion where the first connecting portion and the second connecting portion are joined to the connecting member is provided on an opposite side of the first spring piece and the second spring piece across the linking portion of the clip.

2. The terminal according to claim 1,
wherein each of the first connecting portion and the second connecting portion has a flat plate shape,
the connecting member has a flat plate shape,
the first connecting portion, the second connecting portion, and the connecting member are stacked in a second direction that is perpendicular to the first direction, and
the joint portion is a portion where the first connecting portion, the second connecting portion, and the connecting member are welded.

3. The terminal according to claim 2,
wherein the first connecting portion and the second connecting portion are provided, with the connecting member being interposed therebetween in the second direction.

4. The terminal according to claim 2,
wherein the first connecting portion, the second connecting portion, and the connecting member are stacked on top of each other, with the first connecting portion and the second connecting portion that are directly stacked being placed on the connecting member.

5. The terminal according to claim 2,
wherein the first connecting portion includes a first through hole that extends through the first connecting portion in the second direction,
the second connecting portion includes a second through hole that extends through the second connecting portion in the second direction,
the connecting member includes a third through hole that extends through the connecting member in the second direction, and
the first connecting portion, the second connecting portion, and the connecting member are joined, with the first through hole, the second through hole, and the third through hole being positioned to overlap each other.

6. The terminal according to claim 2,
wherein the connecting member has a thickness thicker than a thickness of the first spring member and the second spring member.

7. The terminal according to claim 2,
wherein the first spring member includes a flat plate-shaped first support portion that extends from an end portion of the first spring piece toward the first direction and a flat plate-shaped first linking portion that links the first support portion and the first connecting portion,
the second spring member includes a flat plate-shaped second support portion that extends from an end portion of the second spring piece toward the first direction and a flat plate-shaped second linking portion that links the second support portion and the second connecting portion,
the first spring piece is bent at an end portion of the first support portion toward the first direction and extends in the first direction at an inclination to be closer to the second spring piece, and
the second spring piece is bent at an end portion of the second support portion toward the first direction and extends in the first direction at an inclination to be closer to the first spring piece.

8. The terminal according to claim 7,
wherein the first spring member and the second spring member are components that are separate from each other, and
the first spring member and the second spring member are configured to have the same structure.

9. A connector comprising:
the terminal according to claim 1; and
a housing that includes a cavity for housing the terminal.

10. The connector according to claim 9,
wherein the housing includes a positioning groove formed in an inner surface of the cavity, and
the terminal includes a positioning protrusion that is provided at the connecting member and configured to be capable of being inserted into the positioning groove in a first opposite direction that is a direction opposite to the first direction.
